(19) United States
(12) Patent Application Publication
(10) Pub. No.: US 2004/0260844 A1
(43) Pub. Date: Dec. 23, 2004

(54) Programmable logic controller with independent pulses generator

(76) Inventor: Chun-Yen Tu, Shan-Ting Tsun (TW)

Correspondence Address: RABIN & CHAMPAGNE, P.C., Suite 500, 1101 14 Street, N.W., Washington, DC, 20005, US

(21) Appl. No.: 10/648,379

(22) Filed: Aug. 27, 2003

(30) Foreign Application Priority Data
Jun. 17, 2003 (TW) 92116440

(51) Int. Cl. G06F 13/10

(52) U.S. Cl. 710/8

(57) ABSTRACT

A programmable logic controller, which removes the function of pulse wave transmission from a microprocessor and accomplishes it by using the microprocessor to output an command data, which defines the frequency and the number of the pulse waves, to a pulse-transmitting unit and, to execute the function of pulse wave transmission.

### BACKGROUND OF THE INVENTION

1. Field of Invention

The invention relates to a programmable logic controller, especially one that is capable of increasing the transmitted pulse wave frequency and reducing the duty cycle error of the programmable logic controller.

2. Related Art

Programmable logic controllers (PLCs) are digital electrical devices that use programmable memory to store instructions for functions such as execution, logic, ordering, timer, counter and calculation, etc, and control machinery or processes through a digital or analog input/output module.

A programmable logic controller not only replaces the traditional relay to execute command data controls, it is also capable of different data calculations, analog input/output, PID control, position control, etc, and can cover the needs of most industrial controls. PLCs are easy to use and maintain, reliable, and flexible in design and application. Therefore, it is easy to foresee the ascendance of the PLC in the automatic control industry in the future.

Currently, there are two methods for fabricating programmable logic controllers. One uses an all-purpose microprocessor, and the other uses the application specific integrated circuit, ASIC.

However, when using the all purpose microprocessor, due to the large amount of tasks it processes in parallel, the microprocessor has a low output pulse wave frequency (only about 40 Hz) and a high duty cycle error (as much as 10%). It also has reduced reliability.

If using ASIC, the complete research and development cost is about NT$500,000 and the manufacturing cost is about NT$1,000,000. Not only is the cost extremely high, but also ASIC is only capable of executing pulse wave transmission. Thus, the method is not very economical.

For these reasons, it is important to invent a reliable programmable logic controller without lost production cost.

### SUMMARY OF THE INVENTION

The invention provides a programmable logic controller that uses a very small microprocessor specifically for transmitting pulse waves to increase output frequency and reduce cost.

To achieve these goals, the programmable logic controller of the invention is comprised of a microprocessor and a pulse-transmitting unit. The pulse-transmitting unit uses two IO ports to connect to the microprocessor. The microprocessor executes a program and outputs a command data with parameters for pulse wave frequency and number of pulse waves. The pulse-transmitting unit transmits the pulse waves accordingly.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 illustrates the electrical circuits of the invention, in block diagram form.

FIG. 2 illustrates the procedures of the microprocessor of the invention. in flow diagram form.

FIG. 3 illustrates the procedures of the pulse-transmitting unit of the invention, in flow diagram form.

### DETAILED DESCRIPTION OF THE INVENTION

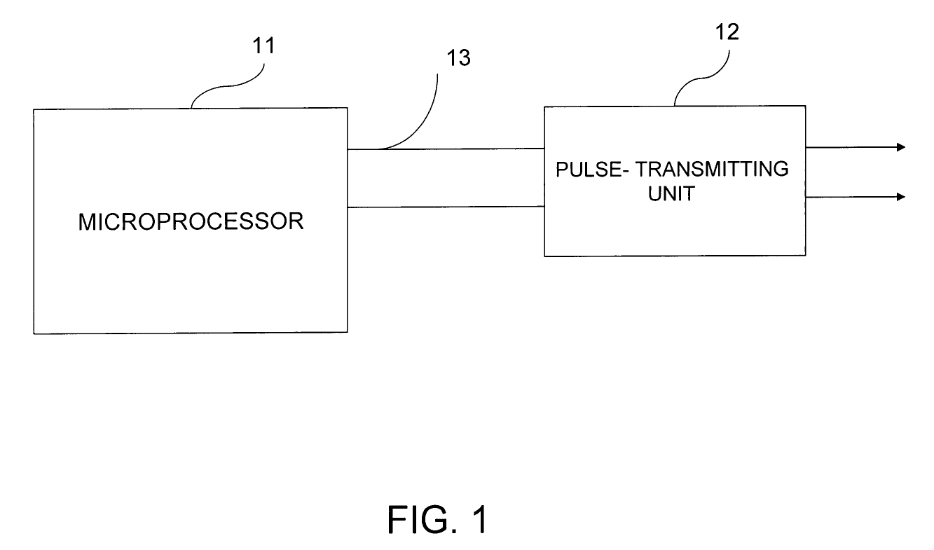

Please refer to FIG. 1 for the illustration of the electrical circuits in block diagram form. The programmable logic controller (PLC) is composed of a microprocessor 11 and a pulse-transmitting unit 12 that is connected to the microprocessor. The microprocessor 11 transmits the command data serially to the pulse-transmitting unit 12 and the pulse waves are transmitted by the unit accordingly.

The microprocessor 11 uses two input/output (IO) ports 13 to connect to the pulse-transmitting unit 12, and it transmits the command data to the unit 12 using these ports 13. The command data is used to define the pulse wave frequency and the number of pulse waves.

The pulse-transmitting unit 12 is an extremely small microprocessor with only eight bits of memory. It is used to receive the command data from microprocessor 11 and transmit the pulse waves following the command data.

Therefore, the microprocessor 11 transmits the command data that defines the pulse wave frequency and number of pulse waves, through the two IO ports 13 serially, to the pulse-transmitting unit 12. The pulse-transmitting unit 12 then transmits the pulse waves according to the pulse wave frequency and the number of pulse waves defined by the command data.

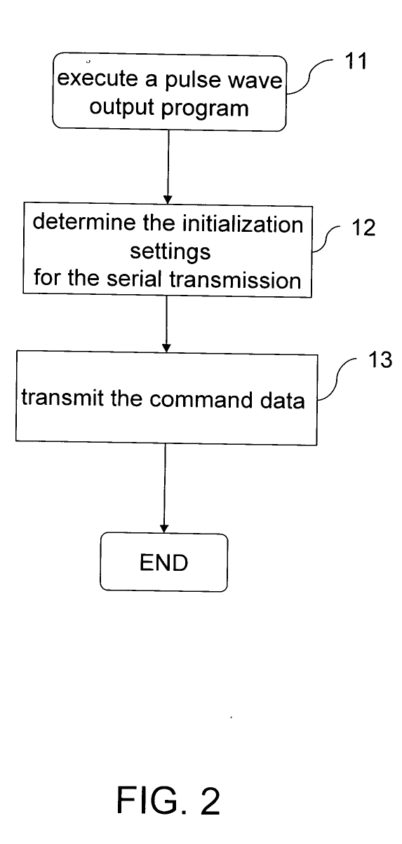

The procedures of the microprocessor in the programmable logic controller are illustrated by the flow diagram in FIG. 2; please refer to FIG. 1 for the system operation structure mentioned by the operation process of the microprocessor procedures. Following are the microprocessor procedures:

First, execute a pulse wave output program (step 11), which is the microprocessor 11 executing a pulse wave transmission program and defining the pulse wave frequency and number of pulse waves.

Next, determine the initialization settings for the serial transmission (step 12), which is the microprocessor setting the initialization value preparing for the serial transmission.

Then, transmit the command data (step 13), which is the microprocessor transmitting the command data with the pulse wave frequency and number of pulse waves via serial connection to the pulse-transmitting unit.

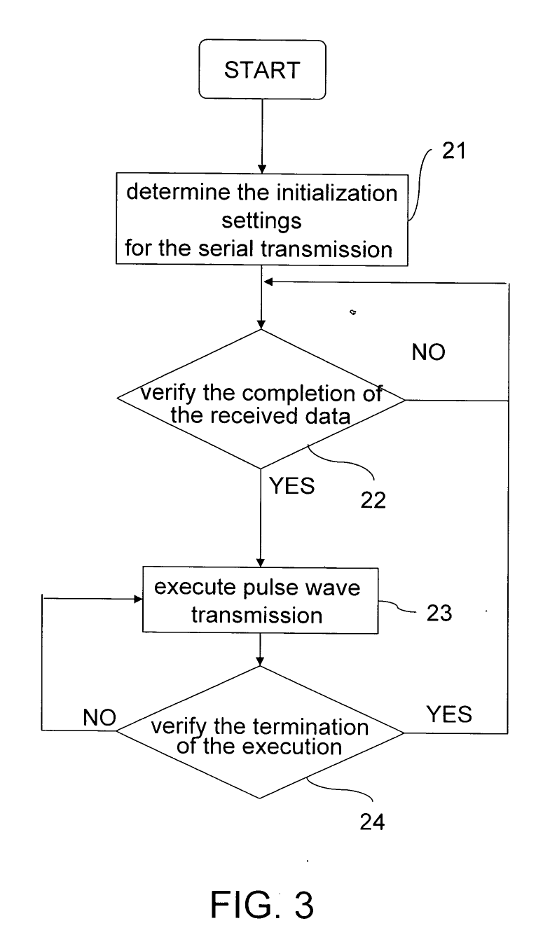

The procedures of the pulse-transmitting unit of the programmable logic controller are illustrated by the flow diagram of FIG. 3; please refer to FIG. 1 for the system operation structure mentioned by the operation process of the pulse-transmitting unit procedures. Following are the pulse-transmitting unit procedures:

First, determine the initialization settings for the serial transmission (step 21), which is the pulse-transmitting unit setting the initialization value preparing for the serial transmission.

Then, verify the completion of the received data (step 22), which is the pulse-generating unit verifying that the received command data is complete. If the received command data is not complete, then re-verify the completion of the received data (step 22).

Next, if the received command data is verified as complete data, then execute pulse wave transmission (step 23), which is the pulse-transmitting unit transmitting the pulse waves according to the pulse wave frequency and number pulse wave defined in the command data.

Finally, verify the termination of the execution (step 24), which is the pulse-transmitting unit verifying that the pulse wave output command has finished executing. If it is not finished, then return to execute pulse wave output (step 23); if it is finished, then return to verify the completion of the received data (step 22).

In conclusion, the invention has the following advantages:

1. The invention separates the pulse-transmission function from the microprocessor, which can increase the maximum pulse wave frequency output by the programmable logic controller up to 200 KHz and decrease the duty cycle error to 1%.

2. The programmable logic controller of the invention has a simple structure and low fabrication cost, which decreases the R&D cost and alters the frequency and quantity of the pulse waves easily.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A programmable logic controller that is used for performing pulse waves outputting, comprising of:
a microprocessor, for executing a pulse wave output program and outputting a command data; and
a pulse-transmitting unit, which is connected to the microprocessor, receiving command data from the microprocessor thereby performing pulse waves outputting.

2. The programmable logic controller in claim 1, wherein the pulse-transmitting unit is connected to the microprocessor via two IO ports.

3. The programmable logic controller in claim 1, wherein the command data is transmitted to the pulse-transmitting unit using a serial transmission.

4. The programmable logic controller in claim 1, wherein the command data defines the pulse wave frequency and the number of pulse waves.

5. The programmable logic controller in claim 1, wherein the pulse-transmitting unit is a small microprocessor with eight-bits of memory.

6. A pulse waves outputting method for a programmable logic controller, comprising the steps of:
executing a pulse wave output program via a microprocessor, and defining the pulse wave frequency and the number of pulse waves;
setting the serial transmitting initialization value via the microprocessor for serial transmitting; and
transmitting the command data which defines the pulse wave frequency and the number of the waves to the pulse-transmitting unit via the microprocessor in serial transmission.

7. A pulse waves outputting method for a programmable logic controller, comprising the steps of:
seting the initialization value of the serial transmission via a pulse-transmitting unit for serial transmission;
verifying the completion of the received data via the pulse-transmitting unit , if the received command data is not complete, then re-verifying the completion of the received data;
executing pulses wave outputting via the pulse-transmitting unit according to the pulse wave frequency and the number of pulse waves defined by the command data; and
verifying finish of the execution of the pulses wave outputting via the pulse-transmitting unit, if the pulse wave transmission command has been completely executed, if not, re-executing the pulse wave transmission, if it is, then re-verifying the completion of the received data.
